(19) United States
(12) Patent Application Publication
(10) Pub. No.: US 2014/0191950 A1
(43) Pub. Date: Jul. 10, 2014

(54) DISPLAY DEVICE FOR NETWORK PAIRING AND NETWORK PAIRING METHOD

(71) Applicant: Samsung Electronics Co., Ltd., Suwon-si (KR)

(72) Inventors: Sung-Jin PARK, Seoul (KR); Seong-Woon KANG, Suwon-si (KR); Young-Woong KIM, Seoul (KR); Kyu-Suk LEE, Suwon-si (KR); Jong-In LEE, Suwon-si (KR); Kyung-Hoon CHA, Yongin-si (KR)

(73) Assignee: Samsung Electronics Co., Ltd., Suwon-si (KR)

(21) Appl. No.: 14/151,169

(22) Filed: Jan. 9, 2014

(30) Foreign Application Priority Data
Jan. 10, 2013 (KR) 10-2013-0002991

(51) Int. Cl. G06F 3/041; G06F 3/01

(52) U.S. Cl. CPC G06F 3/041; G06F 3/017
USPC 345/156

(57) ABSTRACT

A flexible display device for network pairing and a network pairing method are provided. The flexible display device includes an input sensor configured to sense two or more input events generated by an input means, and a controller configured to analyze device information about two or more flexible display devices in response to the sensed input events and, if determining that the sensed input events are for network pairing, to perform network pairing between the two or more flexible display devices.

### CROSS-REFERENCE TO RELATED APPLICATION(S)

This application claims the benefit under 35 U.S.C. §119(a) of a Korean patent application filed on Jan. 10, 2013 in the Korean Intellectual Property Office and assigned Serial number 10-2013-0002991, the entire disclosure of which is hereby incorporated by reference.

### TECHNICAL FIELD

The present disclosure relates to a flexible device for network pairing and a network pairing method. More particularly, the present disclosure relates to a flexible device for facilitating network pairing between flexible devices and a network pairing method.

### BACKGROUND

There have been various technological attempts to develop flexible display devices. Owing to the increased level of technological completeness and productivity of flexible display devices, flexible display devices have recently been commercialized. Since the flexible display devices are bendable or foldable like paper, the flexible display devices are freely transformed and thus readily carried by a user, without occupying much space. Accordingly, the flexible display devices attract much interest due to their enhanced portability. Efforts have been expended toward applying a self-light emitting technology such as Organic Light Emitting Diode (OLED) to portable phones or information terminals. Further, e-paper feeling like paper has become commercialized as an e-paper reader. Techniques to implement this e-paper into a flexible form are also under development.

A flexible display device bendable like paper is fabricated by mounting an ultra-thin circuit on a device and combining a bendable circuit material with an image display material.

To exchange information between a plurality of portable devices, a recent trend is that the locations of the portable devices are detected and indicated to a server and the server connects a portable device to its nearest portable device and thus enables data sharing between the connected portable devices.

Previously, a flexible display device needs to perform a complex connection setup procedure, for data sharing between a plurality of flexible display devices, as described above.

In this context, there is a need for developing a method for facilitating setup of a connection between flexible display devices by detecting a clear connection intent based on paper-like features of the flexible display devices.

Moreover, due to different shapes or usages of devices such as smart phones, to which the flexible display devices are applied, an existing data sharing scheme is not viable for the flexible display devices and interaction for data sharing needs to be implemented in a manner suitable for the flexible display devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a flexible display device for facilitating network pairing between a plurality of flexible display devices and a network pairing method.

In accordance with an aspect of the present disclosure, a flexible display device for network pairing is provided. The flexible display device includes an input sensor configured to sense two or more input events generated by an input means, and a controller configured to analyze device information about two or more flexible display devices in response to the sensed input events and, if determining that the sensed input events are for network pairing, to perform network pairing between the two or more flexible display devices.

In accordance with another aspect of the present disclosure, a network pairing method in a flexible display device is provided. The network pairing method includes sensing two or more input events generated by an input means, analyzing device information about two or more flexible display devices in response to the sensed input events, and if it is determined that the sensed input events are for network pairing, performing network pairing between the two or more flexible display devices.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an overall system that connects a plurality of flexible display devices to each other according to an embodiment of the present disclosure;

FIG. 2 is a block diagram of a flexible display device according to an embodiment of the present disclosure;

FIGS. 3A and 3B illustrate sensing areas defined for a touch sensor in a flexible display device according to an embodiment of the present disclosure;

FIG. 4 is a flowchart illustrating an operation for performing network pairing between flexible display devices according to an embodiment of the present disclosure;

FIG. 5 illustrates a method for sensing an input event for network pairing between flexible display devices according to an embodiment of the present disclosure;

FIG. 6 illustrates a method for sensing an input event for network pairing between flexible display devices according to an embodiment of the present disclosure;

FIGS. 7 and 8 illustrate methods for sensing an input event through a plurality of input means between flexible display devices according to embodiments of the present disclosure; and

FIGS. 9 and 10 illustrate methods for performing network pairing between an even number of flexible display devices according to embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to an embodiment of the present disclosure may be a device equipped with a display. For example, the electronic device may be any of a portable device, a mobile terminal, a communication terminal, a portable communication terminal, a portable mobile terminal, and the like.

The following description will be given in the context of the display device being a smart phone, with the appreciation that a part of the components of the display device may be omitted or modified.

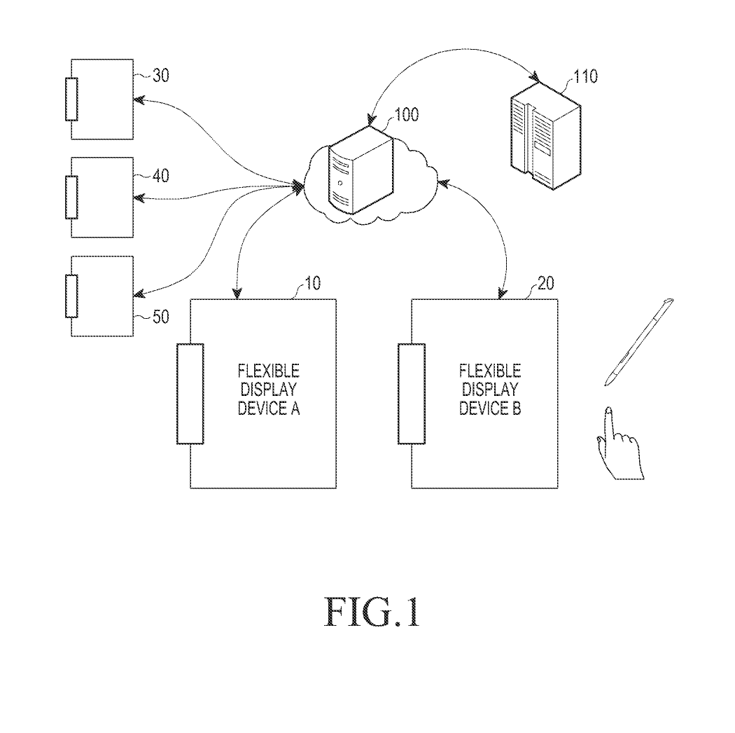

FIG. 1 is a block diagram of an overall system that connects a plurality of flexible display devices to each other according to an embodiment of the present disclosure.

Referring to FIG. 1, the system includes a plurality of flexible display devices 10, 20, 30, 40, and 50, a master device 100 that connects the plurality of flexible display devices 10, 20, 30, 40, and 50 to each other, and an analysis engine 110 that analyzes information about the plurality of flexible display devices 10, 20, 30, 40, and 50.

The flexible display devices 10, 20, 30, 40, and 50 may be connected to each other through the master device 100. Upon generation of an input event through an input means, each of the flexible display devices 10, 20, 30, 40, and 50 transmits its device information to the master device 100. The input means may include a finger an ultrasonic pen, and the like, and the input event may be a touch input, a touch and drag input, or similar input of the input means. The device information about each flexible display device may include network information, position information, input information, and the like about the flexible display device. The input information may include vector timing information and vector direction information about the input event in the flexible display device. The vector timing information may include, for example, an input time in each section of the trajectory of a touch and drag input and the vector direction information may include, for example, a vector direction in each section of the touch and drag input. The input information may further include information about the length of the trajectory of the touch and drag input in the flexible display device. The analysis engine 110 may select two or more flexible display devices having touch and drag trajectories of most approximate lengths, for network pairing.

Upon receipt of input information from the flexible display devices 10, 20, 30, 40, and 50 due to occurrence of an input event, the master device 100 transmits the received input information to the analysis engine 110. If an analysis result of the analysis engine 110 indicates that the input event is for network pairing, the master device 100 connects a flexible display device requesting network pairing to a flexible display device to be paired. For example, if the analysis engine 110 selects the flexible display device 10 (flexible display device A) and the flexible display device 20 (flexible display device B) as a result of the analysis, the master device 100 connects the flexible display device 10 to the flexible display device 20.

The analysis engine 110 may be configured separately from the master device 100 or may be incorporated into the master device 100. Upon receipt of device information about a plurality of flexible display devices from the master device 100, the analysis engine 110 detects flexible display devices near to each other based on the received device information.

For example, the analysis engine 110 detects flexible display devices nearest to each other by analyzing network information and position information about each flexible display device. For example, if flexible display devices have the same network information and are located within a radius of 1 meter from each other, the analysis engine 110 may determine that the flexible display devices are nearest to each other.

The analysis engine 110 detects flexible display devices having most similar input information by analyzing input information about the two or more flexible display devices determined to be nearest to each other. For example, the analysis engine 110 analyzes vector timing information and vector direction information about the two or more flexible display devices. For example, the analysis engine 110 analyzes vector timing information and vector direction information about the trajectory of a touch and drag input of a finger or an ultrasonic pen to each of the flexible display devices. The vector timing information specifies an input time determined in each section of the trajectory of the touch and drag input and the vector direction information specifies a vector direction determined in each section of the trajectory of the touch and drag input.

The analysis engine 110 detects flexible display devices having an input time per section and a vector direction per section within threshold ranges as a result of the analysis and transmits the search result to the master device 100.

In addition, the analysis engine 110 may detect two or more flexible display devices having touch and drag trajectories of most approximate lengths and may select two or more flexible display devices having input times per section and vector directions per section within threshold ranges and having touch and drag trajectories of lengths within a threshold range, for network pairing. In other words, the analysis engine 110 determines whether the length of a touch and drag trajectory in each flexible display device falls into the threshold range.

According to an embodiment of the present disclosure, the master device 100 may be a cloud server or a flexible display device serving as a server. If the master device 100 is a cloud server, the master device 100 may be provided in the analysis engine 110. If the master device 100 is a flexible display device, the master device 100 may also be provided in the analysis engine 110.

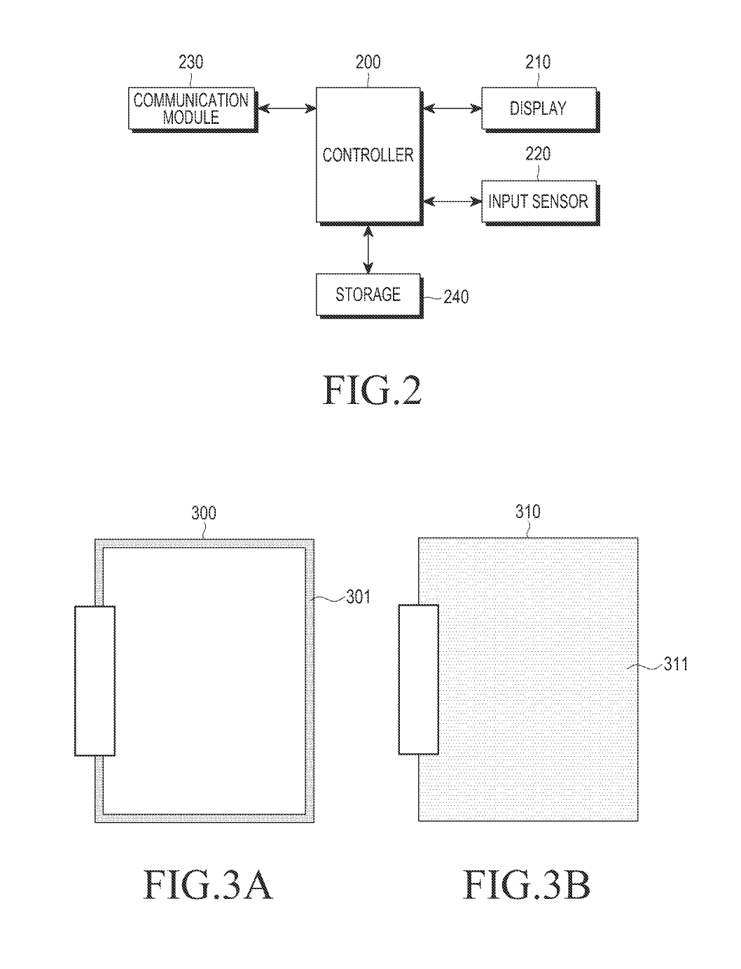

FIG. 2 is a block diagram of a flexible display device according to an embodiment of the present disclosure.

Referring to FIG. 2, the flexible display device includes a controller 200, a display 210, an input sensor 220, a communication module 230, and a storage 240. In an embodiment of the present disclosure, the following description will be given with the appreciation that the master device 100 is a flexible display device and the controller 220 performs the functionalities of the analysis engine 110, by way of example.

The controller 200 provides overall control to the flexible display device. For example, the controller 200 controls the display 210, the input sensor 220, the communication module 230, and the storage 240.

Upon receipt of device information about flexible display devices along with sensing of input events at the input sensor 220, the controller 200 analyzes the received device information. The input event may be a touch and drag input of a finger or an ultrasonic pen. The device information about each flexible display device may include network information, position information, and input information about the flexible display device. The input information about the flexible display device may include vector timing information and vector direction information about an input event generated by the input means. The input information about the flexible display device may further include information about the length of the trajectory of a touch and drag input.

That is, the controller 200 analyzes the network information and position information in the received device information and detects flexible display devices nearest to each other as a result of the analysis. The controller 200 selects flexible display devices that have the same network information and that are apart from each other within a threshold distance as mutually nearest.

The controller 200 analyzes the input information about the determined flexible display devices and detects flexible display devices having most similar input information as a result of the analysis.

Subsequently, the controller 200 connects the detected flexible display devices to each other.

For example, the controller 200 detects flexible display devices having input times per section and vector directions per section within thresholds by analyzing the vector timing information and vector direction information about the flexible display devices and performs network pairing between the detected flexible display devices.

In other words, the controller 200 determines for each flexible display device whether an input time difference per section falls into a time difference threshold and an angle difference per section in regards to a vector direction falls into an angle difference threshold. The controller 200 detects two or more flexible display devices having time differences within the time difference threshold and angle differences within the angle difference threshold and performs network pairing between the detected two or more flexible display devices.

If the input information about each flexible display device includes information about a trajectory length, the controller 200 further compares the lengths of the touch and drag trajectories of the flexible display devices and determines whether a trajectory length difference of each flexible display device falls into a length difference threshold. Subsequently, the controller 200 may detect two or more flexible display devices having time differences within the time difference threshold, angle differences within the angle difference threshold, and trajectory length differences within the trajectory length difference threshold.

For example, the controller 200 may determine a similarity score for each flexible display device by quantifying similarities between flexible display devices and may determine two or more flexible display devices having highest similarity scores to be network-paired.

For example, if a time difference is equal to or less than 1 second, 3 seconds, and 5 seconds, scores of 10, 8, and 6 are assigned respectively and otherwise, a score of 0 is assigned. The controller 200 determines a similarity score corresponding to a range within which a time difference between a specific flexible display device and another flexible display device falls.

If an angle difference is equal to or less than 3 degrees, 5 degrees, and 10 degrees, scores of 10, 8, and 6 are assigned respectively and otherwise, a score of 0 is assigned. The controller 200 determines a similarity score corresponding to a range within which an angle difference between a specific flexible display device and another flexible display device falls.

If a trajectory length difference is equal to or less than 0.5 cm, 0.8 cm, and 1 cm, scores of 10, 8, and 6 are assigned respectively and otherwise, a score of 0 is assigned. The controller 200 determines a similarity score corresponding to a range within which a trajectory length difference between a specific flexible display device and another flexible display device falls.

The controller 200 may determine the sum of similarity scores for each flexible display device, compare the sums, and perform network pairing between two or more flexible display devices having highest similarity scores.

The present disclosure is not limited to the above description and it is to be clearly understood that many other parameters may be used for network pairing.

The display 210 displays function menus executed in the flexible display device, user-input information, and/or information provided to a user. The display 210 may be any display device such as an Organic Light Emitting Diode (OLED) display. For example, the display 210 is configured with a bendable or foldable thin substrate such as flexible plastic. Thus, a display device such as e-paper, a Liquid Crystal Display (LCD), a Plasma Display Panel (PDP), and/or Organic LED (OLED) may be used for the display 210.

The input sensor 220 senses an input event generated by an input means such as a finger or an ultrasonic pen, receives device information about a flexible display device in regards to the sensed input event, and transmits the device information to the controller 200, which will be described with reference to FIGS. 3A and 3B.

FIGS. 3A and 3B illustrate sensing areas defined for a touch sensor in a flexible display device according to an embodiment of the present disclosure.

Referring to FIGS. 3A and 3B, the input sensor 220 may sense an input event generated in an edge area 301, defined along edges of the display 210 in a flexible display device 300, as illustrated in FIG. 3A or in an entire area 311 of the display 210 in a flexible display device 310, as illustrated in FIG. 3B.

The communication module 230 connects the flexible display device to an external device by communication under the control of the controller 200.

The storage 240 may store input/output signals or data in correspondence with an operation of the display 210, the input sensor 220, or the communication module 230 under the control of the controller 200. The storage 240 may also store a control program for controlling the flexible display device or performing a control operation in the controller 200, and applications.

In another embodiment of the present disclosure, upon generation of an input event requesting network pairing from an input means, the controller 200 transmits device information about two or more flexible display devices in relation to the input event to the master device 100. The master device 100 may analyze the device information through the analysis engine 110 and perform network pairing between two or more flexible display devices according to an analysis result.

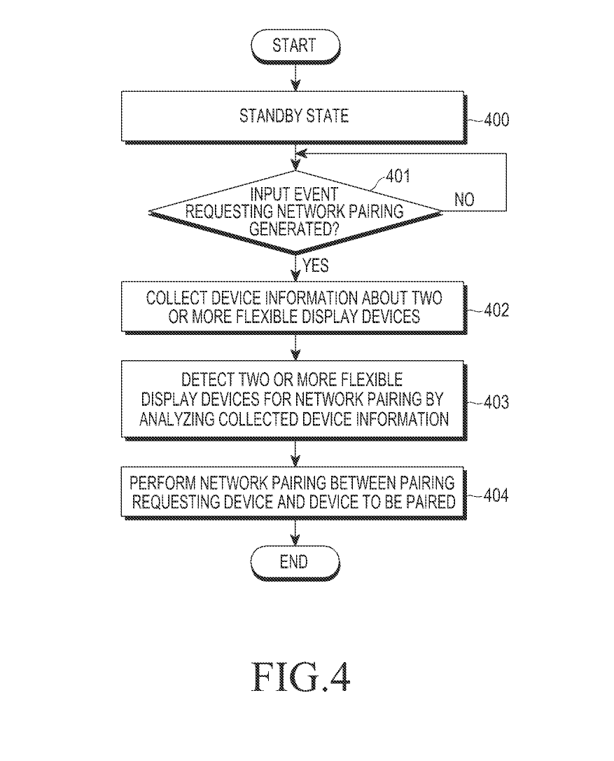

FIG. 4 is a flowchart illustrating an operation for performing network pairing between flexible display devices according to an embodiment of the present disclosure.

Referring to FIG. 4, the flexible display devices are placed in standby state in operation 400.

In operation 401, the controller 200 determines whether an input event requesting network pairing has occurred by an input means through the input sensor 220. Upon occurrence of the input event requesting network pairing, the controller 200 proceeds to operation 402. If the input event requesting network pairing has not occurred, the controller 200 monitors occurrence of the input event requesting network pairing by the input means in operation 401. The input event may include a touch and drag input of a finger or an ultrasonic pen.

In operation 402, the controller 200 collects device information about two or more flexible display devices. For example, upon receipt of device information from each flexible display device along with the occurrence of the input event, the controller 200 stores the received device information in the storage 240.

The controller 200 detects two or more flexible display devices for network pairing by analyzing the collected device information in operation 403. For example, the controller 200 analyzes network information and position information about each flexible display device and determines mutually nearest flexible display devices based on an analysis result. Subsequently, the controller 200 analyzes input information about the mutually nearest flexible display devices and detects flexible display devices having most similar input information based on an analysis result.

In operation 404, the controller 200 performs network pairing between a flexible display device requesting network pairing and a flexible display device to be network-paired. That is, the controller 200 performs network pairing between the detected flexible display devices.

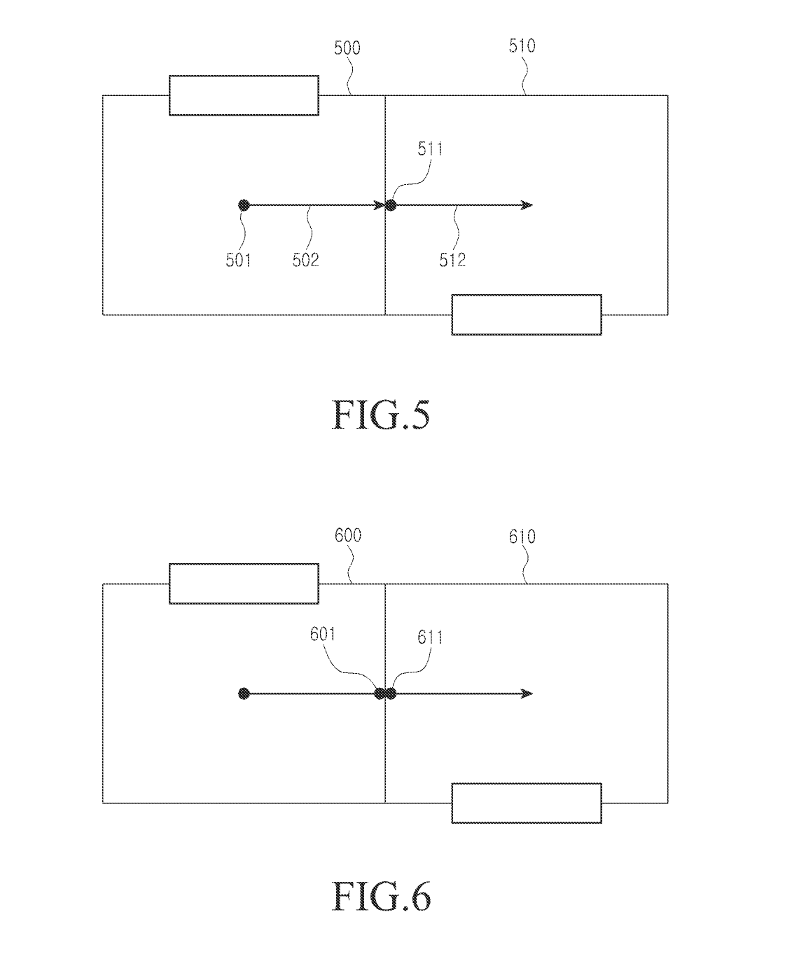

FIG. 5 illustrates a method for sensing an input event for network pairing between flexible display devices according to an embodiment of the present disclosure.

Referring to FIG. 5, it is assumed that a first flexible display device 500 and a second flexible display device 510 are brought into contact, for network pairing.

The input sensor 220 senses a touch and drag input of an input means. For example, the input sensor 220 senses a touched position 501 and a trajectory direction 502 of the drag in the first flexible display device 500. The input sensor 220 also senses a touched position 511 and a trajectory direction 512 of the drag in the second flexible display device 510.

Thus, the controller 200 determines a similarity between the first flexible display device 500 and the second flexible display device 510 by comparing the first and second flexible display devices 500 and 510 in terms of timing information per section, direction information per section, and a trajectory length of the touch and drag input. If determining that the first flexible display device 500 is similar to the second flexible display device 510, the controller 200 performs network pairing between the first flexible display device 500 and the second flexible display device 510.

FIG. 6 illustrates a method for sensing an input event for network pairing between flexible display devices according to another embodiment of the present disclosure.

Referring to FIG. 6, it is assumed that a first flexible display device 600 and a second flexible display device 610 are brought into contact, for network pairing.

The input sensor 220 senses a touch and drag input of an input means in the first flexible display device 600 and the second flexible display device 610. The controller 200 determines whether an ending position 601 of the touch and drag on a screen of the first flexible display device 600 coincides with a starting position 611 of the touch and drag on a screen of the second flexible display device 610. If the ending position 601 of the touch and drag coincides with the starting position 611 of the touch and drag, the controller 200 performs network pairing between the first flexible display device 600 and the second flexible display device 610.

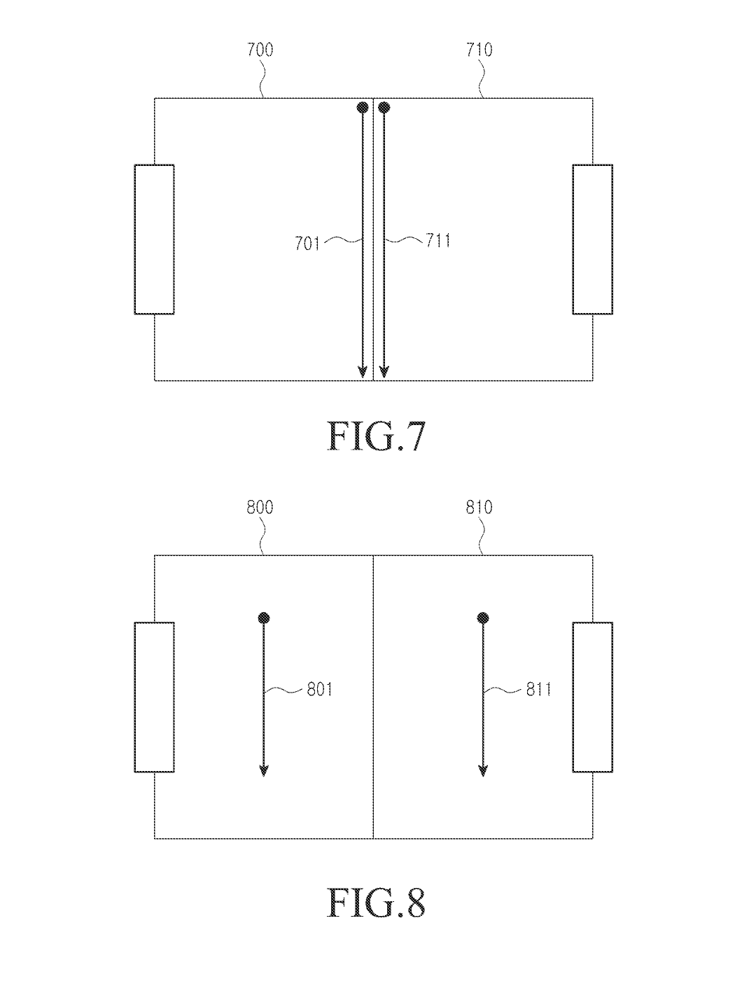

FIGS. 7 and 8 illustrate methods for sensing two or more input events through an input means between flexible display devices according to embodiments of the present disclosure.

In the various embodiments of the present disclosure, network pairing is performed between two flexible display devices by determining whether two or more input events have occurred substantially simultaneously and whether the simultaneous input events are similar.

Referring to FIG. 7, the input sensor 220 senses two or more touch and drag inputs in an area including the boundary between a first flexible display device 700 and a second flexible display device 710.

The controller 200 determines whether the sensed touch and drag inputs are substantially simultaneous. If the sensed touch and drag inputs are substantially simultaneous, the controller 200 analyzes device information about the first and second flexible display devices 700 and 710. The controller 200 performs network pairing between the first and second flexible display devices 700 and 710 according to an analysis result.

For example, the input sensor 220 senses a touch and drag 701 input to a screen of the first flexible display device 700 and a touch and drag 711 input to a screen of the second flexible display device 710.

The controller 200 analyzes the device information about the first and second flexible display devices 700 and 710 in regards to the touch and drag inputs 701 and 711 and determines whether the touch and drag inputs 701 and 711 are similar in terms of vector direction information per section, vector timing information per section, a trajectory length, and the like, based on an analysis result.

If the touch and drag inputs 701 and 711 are similar, the controller 200 performs network pairing between the first and second flexible display devices 700 and 710.

Referring to FIG. 8, if a touch and drag 801 is input to a screen of a first flexible display device 800 and a touch and drag 811 is input to a screen of a second flexible display device 810, the controller 200 determines whether the touch and drag inputs 801 and 811 are similar in terms of vector direction information per section, vector timing information per section, and a trajectory length, based on an analysis result.

If the touch and drag inputs 801 and 811 are similar, the controller 200 performs network pairing between the first and second flexible display devices 800 and 810.

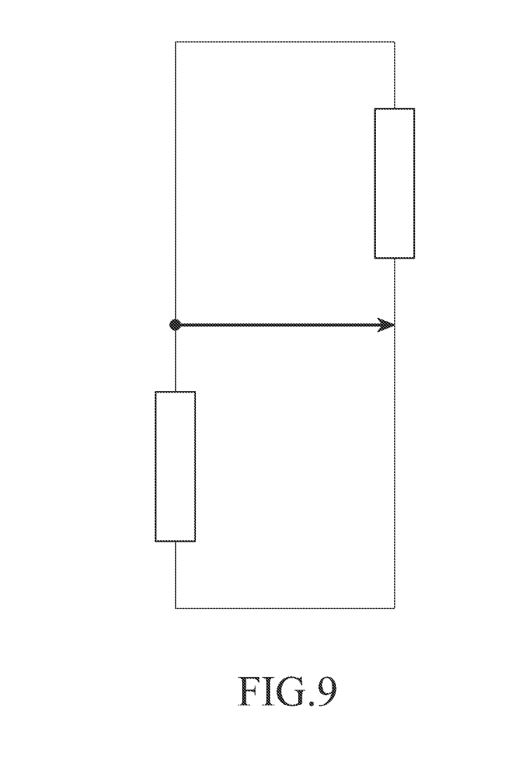

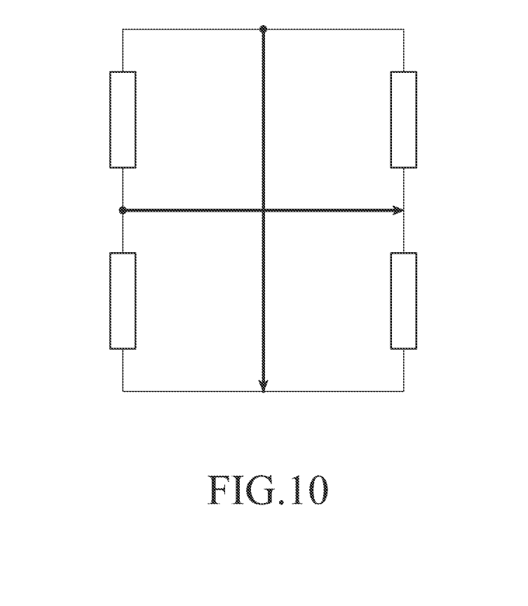

FIGS. 9 and 10 illustrate methods for performing network pairing between an even number of flexible display devices according to embodiments of the present disclosure.

Referring to FIG. 9, network pairing may be performed between two flexible display devices brought into contact by a single touch and drag input across the two flexible display devices.

Referring to FIG. 10, network pairing may be performed between four flexible display devices brought into contact by two single touch and drag inputs to the four flexible display devices.

As is apparent from the above description of the present disclosure, since interaction is simplified for network pairing between two or more flexible display devices, network pairing is facilitated and a network pairing time is shortened.

It will be understood that the various embodiments of the present disclosure can be implemented in hardware, software, or a combination thereof. The software may be stored in a volatile or non-volatile memory device like a Read Only Memory (ROM) irrespective of whether data is erasable or rewritable, in a memory like a Random Access Memory (RAM), a memory chip, a device, or an integrated circuit, or in a storage medium to which data can be recorded optically or magnetically and from which data can be read by a machine (e.g. a computer), such as a Compact Disk (CD), a Digital Versatile Disk (DVD), a magnetic disk, or a magnetic tape.

Further, embodiments of the network pairing method of the present disclosure can be implemented in a computer or portable terminal that has a controller and a memory, and the memory is an example of a machine-readable (computer-readable) storage medium suitable for storing a program or programs including commands to implement the various embodiments of the present disclosure. Accordingly, embodiments of the present disclosure include a program having a code for implementing the apparatus or method defined by the claims and a non-transitory storage medium readable by a machine that stores the program.

A flexible display device according to an embodiment of the present disclosure can receive the program from a flexible display device connected by cable or wirelessly and store the program. The flexible display device may include a program including commands to implement the various embodiments of the present disclosure, a memory for storing information required for the various embodiments of the present disclosure, a communication module for communicating with the flexible display device by cable or wirelessly, and a controller for transmitting the program to the flexible display device automatically or upon request of the flexible display device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A flexible display device for network pairing, the flexible display device comprising:
an input sensor configured to sense two or more input events generated by an input means; and
a controller configured to analyze device information about two or more flexible display devices in response to the sensed input events and, if determining that the sensed input events are for network pairing, to perform network pairing between the two or more flexible display devices.

2. The flexible display device of claim 1, wherein the device information about the two or more flexible display devices includes at least one of network information, position information, and input information about the two or more flexible display devices.

3. The flexible display device of claim 2, wherein the controller determines whether the network information and the position information about the two or more flexible display devices are similar by analyzing the network information and the position information about the two or more flexible display devices, detects two or more flexible display devices having similar network information and position information, and determines whether input information about the detected two or more flexible display devices is similar.

4. The flexible display device of claim 3, wherein the controller detects two or more flexible display devices having identical network information and position information with a difference equal to or less than a threshold.

5. The flexible display device of claim 4, wherein the controller analyzes the input information about the detected two or more flexible display devices and performs network pairing between two or more flexible display devices having similar input information.

6. The flexible display device of claim 5, wherein the input information about the detected two or more flexible display devices includes at least one of vector timing information per section, vector direction information per section, and trajectory length information about the detected two or more flexible display devices.

7. The flexible display device of claim 6, wherein the controller detects two or more flexible display devices having at least one of similar vector timing information per section, similar vector direction information per section, and similar trajectory length information and performs network pairing between the detected two or more flexible display devices.

8. The flexible display device of claim 7, wherein the controller detects similar vector timing information per section, similar vector direction information per section, and similar trajectory length information by respectively determining an input time per section is within a first threshold range, a vector direction per section is within a second threshold range, and a trajectory length per section is within a third threshold range.

9. The flexible display device of claim 6, wherein each of the two or more input events comprises a touch and drag input, the vector timing information per section comprises an input time in each section of the trajectory of the touch and drag inputs, respectively, and the vector direction information comprises a vector direction in each section of the touch and drag inputs, respectively.

10. A network pairing method in a flexible display device, the network pairing method comprising:
sensing two or more input events generated by an input means;
analyzing device information about two or more flexible display devices in response to the sensed input events; and
if it is determined that the sensed input events are for network pairing, performing network pairing between the two or more flexible display devices.

11. The network pairing method of claim 10, wherein the device information about the two or more flexible display devices includes at least one of network information, position information, and input information about the two or more flexible display devices.

12. The network pairing method of claim 11, wherein the analyzing of device information comprises:
determining whether the network information and the position information about the two or more flexible display devices are similar by analyzing the network information and the position information about the two or more flexible display devices;
detecting two or more flexible display devices having similar network information and position information; and
determining whether input information about the detected two or more flexible display devices is similar.

13. The network pairing method of claim 12, wherein the performing of network pairing comprises detecting two or more flexible display devices having identical network information and position information with a difference equal to or less than a threshold.

14. The network pairing method of claim 13, wherein the performing of network pairing comprises analyzing the input information about the detected two or more flexible display devices and performing network pairing between two or more flexible display devices having similar input information.

15. The network pairing method of claim 14, wherein the input information about the detected two or more flexible display devices includes at least one of vector timing information per section, vector direction information per section, and trajectory length information about the detected two or more flexible display devices.

16. The network pairing method of claim 15, wherein the performing of network pairing comprises:
detecting two or more flexible display devices having at least one of similar vector timing information per section, similar vector direction information per section, and similar trajectory length information; and
performing network pairing between the detected two or more flexible display devices.

17. The network pairing method of claim 16, wherein the detecting of the similar vector timing information per section, similar vector direction information per section, and similar trajectory length information comprises respectively determining an input time per section is within a first threshold range, a vector direction per section is within a second threshold range, and a trajectory length per section is within a third threshold range.

18. The network pairing method of claim 15, wherein each of the two or more input events comprises a touch and drag input, the vector timing information per section comprises an input time in each section of the trajectory of the touch and drag inputs, respectively, and the vector direction information comprises a vector direction in each section of the touch and drag inputs, respectively.
